(19) United States
(12) Patent Application Publication
(10) Pub. No.: US 2025/0256557 A1
(43) Pub. Date: Aug. 14, 2025

(54) Protective Vehicle Cover Device

(71) Applicant: Gerardo Escobedo, Midland, TX (US)

(72) Inventor: Gerardo Escobedo, Midland, TX (US)

(21) Appl. No.: 18/440,157

(22) Filed: Feb. 13, 2024

(51) Int. Cl. B60J 11/04

(52) U.S. Cl. CPC B60J 11/04

(57) ABSTRACT

A protective vehicle cover device for protecting a body of a vehicle from impact damage caused by hail includes a plurality of panels that are pivotably coupled together. Each panel of the plurality of panels includes a resiliently compressible material that inhibits impact damage to a vehicle over which the plurality of panels is positioned. The plurality of panels includes a plurality of hood panels, a plurality of front windshield panels, a plurality of roof panels, a plurality of rear windshield panels, and a plurality of trunk panels. A plurality of fasteners is coupled to the plurality of panels to releasably affix the plurality of panels to the vehicle. A pair of sleeves is positionable over a pair of side mirrors of the vehicle. Each sleeve of the pair of sleeves comprises the resiliently compressible material.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to car cover and more particularly pertains to a new car cover for protecting a body of a vehicle from impact damage caused by hail.

### (2) Description of Related Art Including Information Disclosed Under 37 CFR 1.97 and 1.98

The prior art relates to car covers. Vehicle covers are used to protect the paint and body of a vehicle from damage. For example, the prior art discloses blankets and tarps that can be positioned over a vehicle when the vehicle is parked to inhibit dust and other debris from building up on the surface of the vehicle. People who do not have a garage, or whose garage space does not accommodate their vehicle, must park their vehicle outside each day. Parking outside can result in environmental damage to the vehicle, for example from hail, tree branches, or other debris flying through the air. The prior art blankets provide little or no protection from such impact damage, which can be costly to repair. Thus, there is a need in the art for a protective cover that a user can easily position over their vehicle to protect the vehicle from impact damage. Ideally, the device would be lightweight and easy to store when the device is not being used.

### BRIEF SUMMARY OF THE INVENTION

An embodiment of the disclosure meets the needs presented above by generally comprising a plurality of panels that are coupled together. Each panel of the plurality of panels is pivotable with respect to an adjacent panel of the plurality of panels wherein a shape of the plurality of panels is configured to complement to a shape of a vehicle when the plurality of panels is positioned over the vehicle. Each panel of the plurality of panels comprises a resiliently compressible material that is configured to inhibit impact damage to the vehicle when the plurality of panels is positioned over the vehicle. The plurality of panels further comprises a plurality of hood panels that is configured to be positioned over a front end of the vehicle wherein the front end includes at least one of a hood, a grill, and a pair of headlights. A plurality of front windshield panels is configured to be positioned over a front windshield of the vehicle. A plurality of roof panels is configured to be positioned over a midsection of the vehicle wherein the midsection extends between the front windshield and a rear windshield of the vehicle. A plurality of rear windshield panels is configured to be positioned over the rear windshield of the vehicle. A plurality of trunk panels is configured to be positioned over a rear end of the vehicle wherein the rear end includes at least one of a trunk and a pair of taillights. A plurality of fasteners is coupled to the plurality of panels. The plurality of fasteners is configured to releasably affix the plurality of panels to the vehicle. A pair of sleeves is configured to be positionable over a pair of side mirrors of the vehicle. Each sleeve of the pair of sleeves comprises the resiliently compressible material.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a protective vehicle cover device according to an embodiment of the disclosure.

FIG. 2 is a bottom view of an embodiment of the disclosure.

FIG. 3 is a top view of an embodiment of the disclosure.

FIG. 4 is a cross-sectional view of an embodiment of the disclosure.

FIG. 5 is an isometric view of an embodiment of the disclosure.

FIG. 6 is an in-use view of an embodiment of the disclosure.

FIG. 7 is an in-use view of an embodiment of the disclosure.

### DETAILED DESCRIPTION OF THE INVENTION

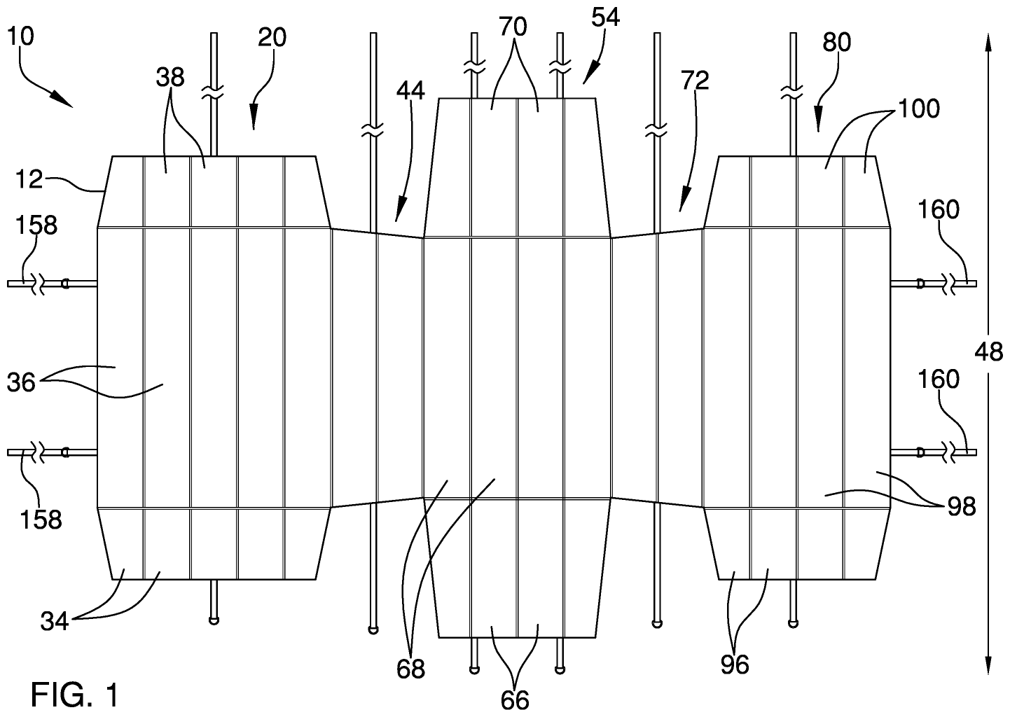

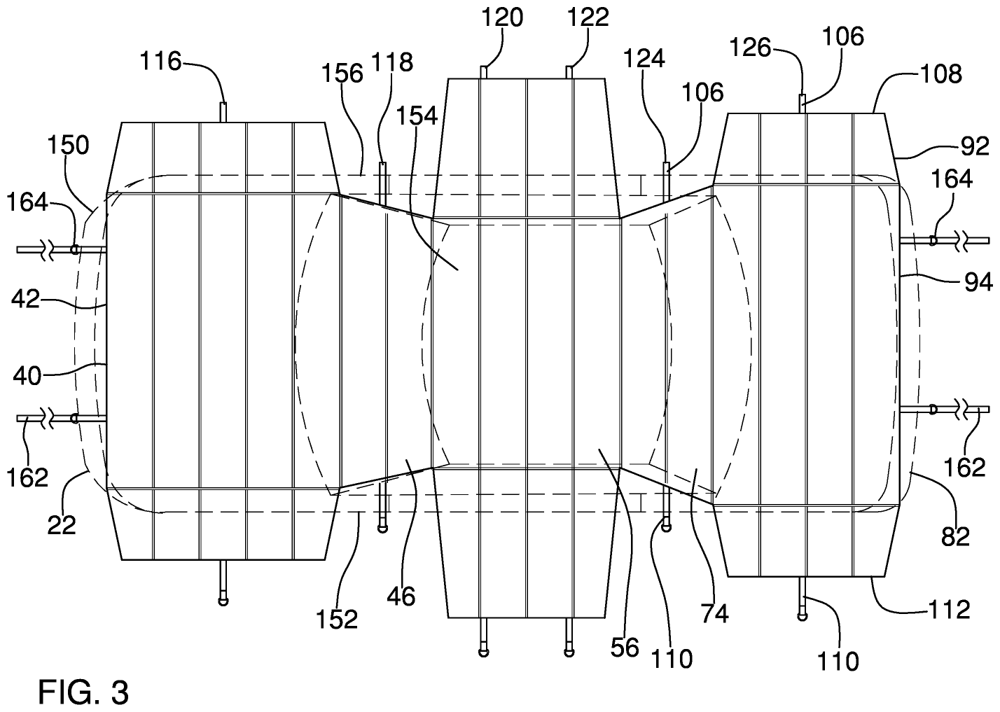

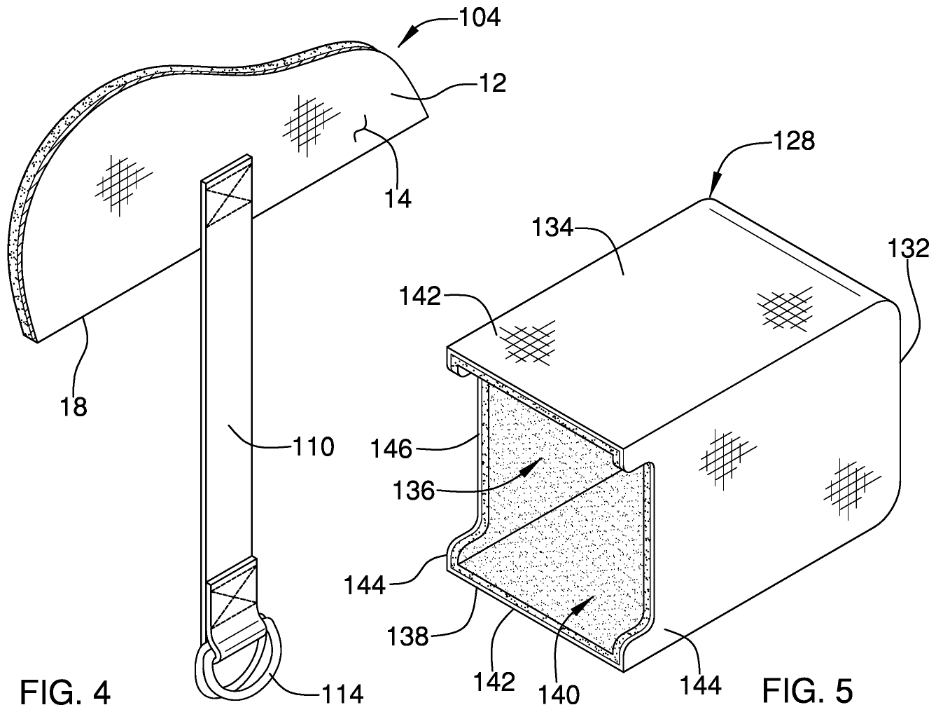

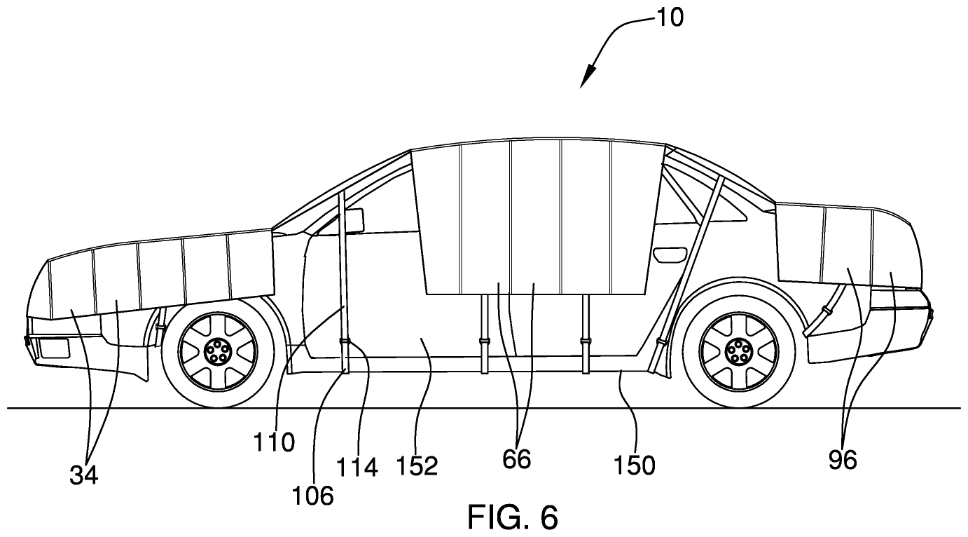

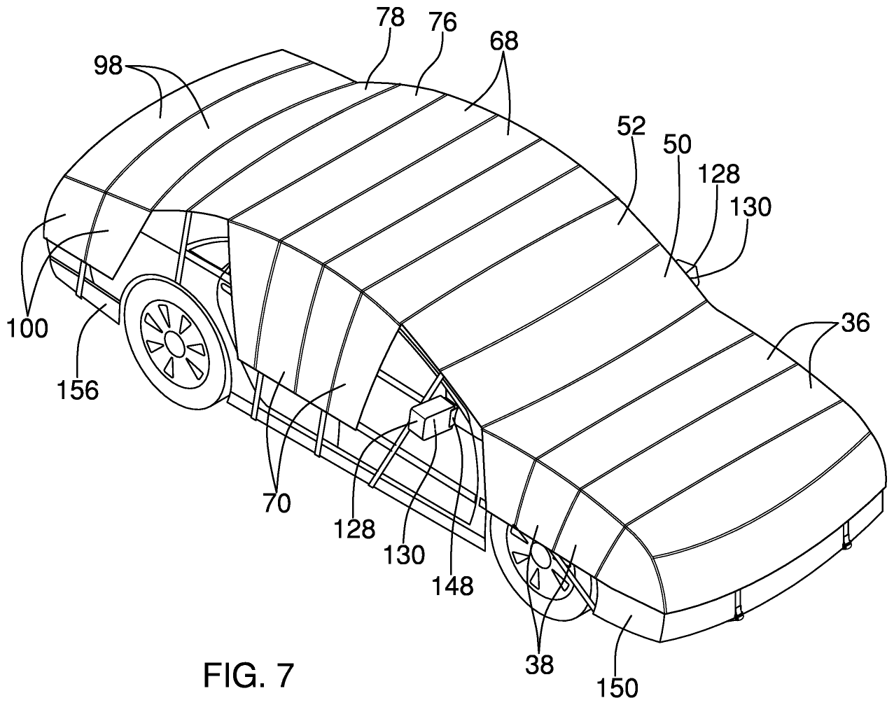

With reference now to the drawings, and in particular to FIGS. 1 through 7 thereof, a new car cover embodying the principles and concepts of an embodiment of the disclosure and generally designated by the reference numeral 10 will be described.

As best illustrated in FIGS. 1 through 7, the protective vehicle cover device 10 generally comprises a plurality of panels 12 that are connected together. Each panel of the plurality of panels is pivotable with respect to an adjacent panel of the plurality of panels 12. For example, each panel of the plurality of panels 12 may pivot upwardly, downwardly, or both upwardly and downwardly relative to the adjacent panel of the plurality of panels 12. The shape of the plurality of panels 12, and the relative pivoting of each panel of the plurality of panels 12 relative to the adjacent panel of the plurality of panels 12, is configured to conform to a shape of a vehicle 150 when the plurality of panels 12 is positioned over the vehicle 150.

Each panel of the plurality of panels 12 generally has a top surface 14, a bottom surface 16, and a peripheral edge 18 that is coupled to and extends between the top surface 14 and the bottom surface 16. Each panel of the plurality of panels 12 comprises a resiliently compressible material that is configured to inhibit impact damage to the vehicle 150 when the plurality of panels 12 is positioned over the vehicle 150. The resiliently compressible material may comprise one of a high-density foam material and a sponge rubber material. For example, the sponge rubber material may include polychloroprene. Each panel of the plurality of panels 12 may have a thickness between 0.25 inch and 1.5 inch.

The plurality of panels 12 may further comprise a plurality of hood panels 20 that is configured to be positioned over a front end 22 of the vehicle 150. For example, the front end 22 may include at least one of a hood, a grill, a front bumper, and a pair of headlights. The plurality of hood panels 20 may be octagonal.

The plurality of hood panels 20 may further comprise a first hood panel 24. For example, the first hood panel 24 may be hexagonal. The first hood panel 24 may have a free edge 40 that defines a forward edge 42 of the plurality of panels 12. A second hood panel 26 may be pivotably coupled to the first hood panel 24. The second hood panel 26 may be rectangular. A third hood panel 28 may be pivotably coupled to the second hood panel 26. The third hood panel 28 may be rectangular. A fourth hood panel 30 may be pivotably coupled to the third hood panel 28. The fourth hood panel 30 may be rectangular. A fifth hood panel 32 may be pivotably coupled to the fourth hood panel 30. The fifth hood panel 32 may be hexagonal.

The precise shape and number of hood panels included in the plurality of hood panels 20 may vary depending on the type of the vehicle 150 with which the protective vehicle cover device 10 is being used. For example, a smaller vehicle 150 may include fewer hood panels in the plurality of hood panels 20 than a larger vehicle 150. Additionally, the shape of the plurality of hood panels 20, both individually and collectively, may be tailored to the shape of the front end 22 of the vehicle 150 to offer adequate coverage and protection of the front end 22 of the vehicle 150.

Each hood panel of the plurality of hood panels 20 may further comprise a driver's side hood panel piece 34 that is configured to be positioned over a driver's side 152 of the front end 22 of the vehicle 150. A top side hood panel piece 36 may be pivotably coupled to and extend outwardly from the driver's side hood panel piece 34. The top side hood panel piece 36 is generally configured to be positioned over a top side 154 of the front end 22 of the vehicle 150. A passenger's side hood panel piece 38 may be pivotably coupled to and extend outwardly from the top side hood panel piece 36. The passenger's side hood panel piece 38 is generally positioned distally to the driver's side hood panel piece 34, extending outwardly from the opposite side of the top side hood panel piece 36. The passenger's side hood panel piece 38 is generally configured to be positioned over a passenger's side 156 of the front end 22 of the vehicle 150. The three pieces of each hood panel of the plurality of hood panels 20 facilitate wrapping the plurality of hood panels 20 around the front end 22 of the vehicle 150 to protect as much of the body of the vehicle 150 as possible.

A plurality of front windshield panels 44 is configured to be positioned over a front windshield 46 of the vehicle 150. The plurality of front windshield panels 44 may be coupled to and extend outwardly from the plurality of hood panels 20. The plurality of front windshield panels 44 may be trapezoidal, or rectangular, to conform to the shape of the front windshield 46 of the vehicle 150.

The plurality of front windshield panels 44 may have a length 48 that is smaller than a length 48 of the plurality of hood panels 20, for example because the plurality of front windshield panels 44 may not be configured to wrap around the sides of the vehicle 150 like the plurality of hood panels 20. For example, each front windshield panel of the plurality of front windshield panels 44 may only comprise a single piece, rather than the three pieces of each hood panel of the plurality of hood panels 20.

In certain embodiments, the plurality of front windshield panels 44 may further comprise a first front windshield panel 50 that may be pivotably coupled to the top side hood panel piece 36 of the fifth hood panel 32. A second front windshield panel 52 may be pivotably coupled to the first front windshield panel 50. The precise number of the front windshield panels of the plurality of front windshield panels 44 may vary depending on the size of the front windshield 46 of the vehicle 150.

A plurality of roof panels 54 is configured to be positioned over a midsection 56 of the vehicle 150. The midsection 56 generally extends between the front windshield 46 and a rear windshield 74 of the vehicle 150. For example, the midsection 56 may include a sunroof, the roof, or the doors and sides of the vehicle 150. The plurality of roof panels 54 may be coupled to and extend outwardly from the plurality of front windshield panels 44.

The plurality of roof panels 54 may have a length 48 exceeding a length 48 of the plurality of front windshield panels 44. The plurality of roof panels 54 may have a length 48 exceeding a length 48 of the plurality of hood panels 20, as well, because the plurality of roof panels 54 may be configured to wrap downwardly around the sides of the vehicle 150 from the roof of the vehicle 150. In certain embodiments, the plurality of roof panels 54 may collectively be octagonal, although other shapes may also be used to conform to the shape of the vehicle 150.

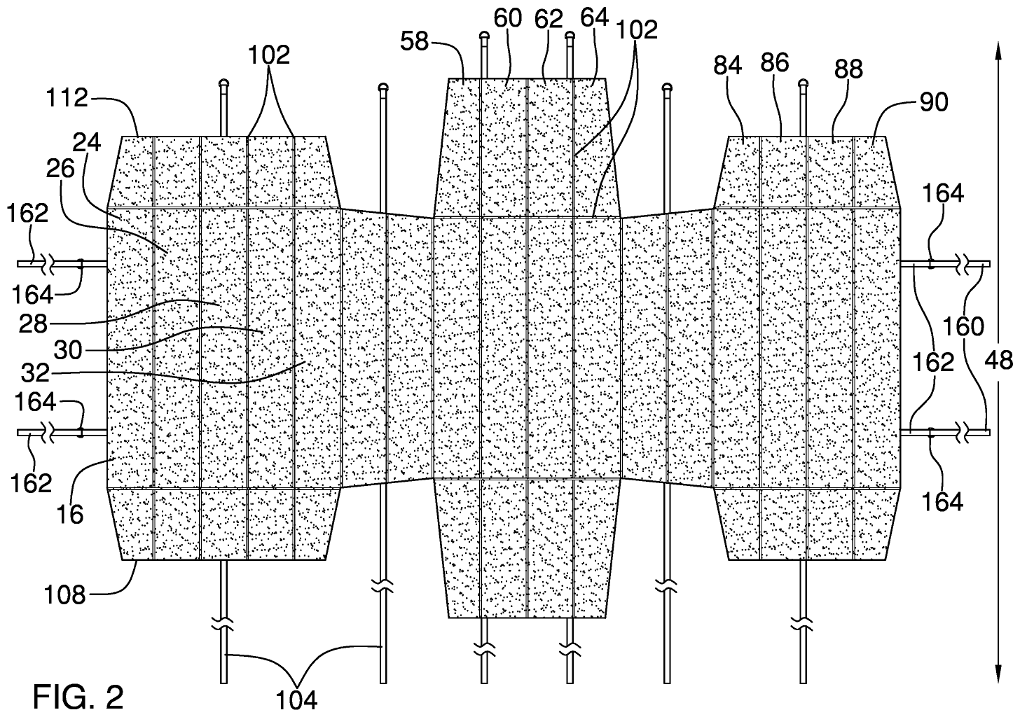

The plurality of roof panels 54 may further comprise a first roof panel 58 that may be pivotably coupled to the second front windshield panel 52. The first roof panel 58 itself may be hexagonal, as shown in FIGS. 1 and 2, although the exact shape may vary across embodiments. A second roof panel 60 may be pivotably coupled to the first roof panel 54. The second roof panel 60 may be rectangular. A third roof panel 62 may be pivotably coupled to the second roof panel 60. The third roof panel 62 may be rectangular. A fourth roof panel 64 may be pivotably coupled to the third roof panel 62. The fourth roof panel 64 may be hexagonal.

The precise shape and number of roof panels included in the plurality of roof panels 54 may vary depending on the type of the vehicle 150 with which the protective vehicle cover device 10 is being used. For example, a smaller vehicle 150 may include fewer roof panels in the plurality of roof panels 54 than a larger vehicle 150. Additionally, the shape of the plurality of roof panels 54, both individually and collectively, may be tailored to the shape of the midsection 56 of the vehicle 150 to offer adequate coverage and protection of the midsection 56 of the vehicle 150.

Each roof panel of the plurality of roof panels 54 may further comprise a driver's side roof panel piece 66 that is configured to be positioned over the driver's side 152 of the midsection 56 of the vehicle 150. A top side roof panel piece 68 may be pivotably coupled to and extend outwardly from the driver's side roof panel piece 66. The top side roof panel piece 68 is generally configured to be positioned over the top side 154 of the midsection 56 of the vehicle 150. A passenger's side roof panel piece 70 may be pivotably coupled to and extend outwardly from the top side roof panel piece 68. The passenger's side roof panel piece 70 is generally positioned distally to the driver's side roof panel piece 66, extending outwardly from the opposite side of the top side roof panel piece 68. The passenger's side roof panel piece 70 is generally configured to be positioned over the passenger's side 156 of the midsection 56 of the vehicle 150. The three pieces of each roof panel of the plurality of roof panels 54 facilitate wrapping the plurality of roof panels 54 around the midsection 56 of the vehicle 150 to protect as much of the body of the vehicle 150 as possible.

A plurality of rear windshield panels 72 is configured to be positioned over the rear windshield 74 of the vehicle 150. The plurality of rear windshield panels 72 may be coupled to and extend outwardly from the plurality of roof panels 54. The plurality of rear windshield panels 72 may be trapezoidal, or rectangular, to conform to the shape of the rear windshield 74 of the vehicle 150.

The plurality of rear windshield panels 72 may have a length 48 that is smaller than a length 48 of the plurality of roof panels 54, for example because the plurality of rear windshield panels 72 may not be configured to wrap around the sides of the vehicle 150 like the plurality of roof panels 54. The plurality of rear windshield panels 72 may have a length 48 that is equivalent to a length 48 of the plurality of front windshield panels 44, for example because the front windshield 46 and the rear windshield 74 of the vehicle 150 have similar or identical dimensions. For example, like the plurality of front windshield panels 44, each rear windshield panel of the plurality of rear windshield panels 72 may comprise a single piece.

In certain embodiments, the plurality of rear windshield panels 72 may further comprise a first rear windshield panel 76 that may be pivotably coupled to the top side roof panel piece 68 of the fourth roof panel 64. A second rear windshield panel 78 may be pivotably coupled to the first rear windshield panel 76. The precise number of the rear windshield panels of the plurality of rear windshield panels 72 may vary depending on the size of the rear windshield 74 of the vehicle 150.

A plurality of trunk panels 80 is configured to be positioned over a rear end 82 of the vehicle 150. For example, the rear end 82 may include at least one of a trunk, a rear bumper, and a pair of taillights. The plurality of trunk panels 80 may be coupled to and extend outwardly from the plurality of rear windshield panels 72.

The plurality of trunk panels 80 may collectively be octagonal, rectangular, or another shape that is complementary to the shape of the rear end 82 of the vehicle 150. The plurality of trunk panels 80 may have a length 48 exceeding a length 48 of the plurality of rear windshield panels 72, for example because the plurality of trunk panels 80 is configured to wrap around the sides of the vehicle 150. The plurality of trunk panels 80 may have a length 48 that is smaller than a length 48 of the plurality of roof panels 54, as shown in FIGS. 1 and 2. For example, the plurality of trunk panels 80 may have a length 48 that is equivalent to a length 48 of the plurality of hood panels 20.

In certain embodiments, the plurality of trunk panels 80 may further comprise a first trunk panel 84 that may be pivotably coupled to the second rear windshield panel 78. The first trunk panel 84 may be hexagonal, although the shape of the individual trunk panels of the plurality of trunk panels 80 may vary to complement, or conform to, the shape of the vehicle 150. A second trunk panel 86 may be pivotably coupled to the first trunk panel 84. The second trunk panel 86 may be rectangular. A third trunk panel 88 may be pivotably coupled to the second trunk panel 86. The third trunk panel 88 may be rectangular. A fourth trunk panel 90 may be pivotably coupled to the third trunk panel 88. The fourth trunk panel 90 may be hexagonal. The fourth trunk panel 90 may have an outer edge 92 that is distal to the third trunk panel 88. The outer edge 92 generally defines a rear edge 94 of the plurality of panels 12.

The precise shape and number of trunk panels included in the plurality of trunk panels 80 may vary depending on the type of the vehicle 150 with which the protective vehicle cover device 10 is being used. For example, a smaller vehicle 150 may include fewer trunk panels in the plurality of trunk panels 80 than a larger vehicle 150. Additionally, the shape of the plurality of trunk panels 80, both individually and collectively, may be tailored to the shape of the rear end 82 of the vehicle 150 to offer adequate coverage and protection of the rear end 82 of the vehicle 150.

Each trunk panel of the plurality of trunk panels 80 may further comprise a driver's side trunk panel piece 96 that is configured to be positioned over the driver's side 152 of the rear end 82 of the vehicle 150. A top side trunk panel piece 98 may be pivotably coupled to and extend outwardly from the driver's side trunk panel piece 96. The top side trunk panel piece 98 is generally configured to be positioned over the top side 154 of the rear end 82 of the vehicle 150. A passenger's side trunk panel piece 100 may be pivotably coupled to and extend outwardly from the top side trunk panel piece 98. The passenger's side trunk panel piece 100 is generally positioned distally to the driver's side trunk panel piece 96, extending outwardly from the opposite side of the top side trunk panel piece 98. The passenger's side trunk panel piece 100 is generally configured to be positioned over the passenger's side 156 of the rear end 82 of the vehicle 150. The three pieces of each trunk panel of the plurality of trunk panels 80 facilitate wrapping the plurality of trunk panels 80 around the rear end 82 of the vehicle 150 to protect as much of the body of the vehicle 150 as possible.

The driver's side roof panel piece 66 of each roof panel of the plurality of roof panels 54 may have a length 48 exceeding a length 48 of the driver's side hood panel piece 34 of each hood panel of the plurality of hood panels 20. The driver's side roof panel piece 66 of each roof panel of the plurality of roof panels 54 may have a length 48 exceeding a length 48 of the driver's side trunk panel piece 96 of each trunk panel of the plurality of trunk panels 80.

The passenger's side roof panel piece 70 of each roof panel of the plurality of roof panels 54 may have a length 48 exceeding a length 48 of the passenger's side hood panel piece 38 of each hood panel of the plurality of hood panels 20. The passenger's side roof panel piece 70 of each roof panel of the plurality of roof panels 54 may have a length 48 exceeding a length 48 of the passenger's side trunk panel piece 100 of each trunk panel of the plurality of trunk panels 80.

The top side roof panel piece 68 of each roof panel of the plurality of roof panels 54 may have a length 48 that is equal to a length 48 of the top side hood panel piece 36 of each hood panel of the plurality of hood panels 20. The top side roof panel piece 68 of each roof panel of the plurality of roof panels 54 may have a length 48 that is equal to a length 48 of the top side trunk panel piece 98 of each trunk panel of the plurality of trunk panels 80.

The plurality of front windshield panels 44 is generally positioned between the plurality of hood panels 20 and the plurality of roof panels 54. The plurality of roof panels 54 is generally positioned between the plurality of front windshield panels 44 and the plurality of rear windshield panels 72. The plurality of rear windshield panels 72 is generally positioned between the plurality of roof panels 54 and the plurality of trunk panels 80.

A coupler material 102 may pivotably connect each panel of the plurality of panels 12 to an adjacent panel of the plurality of panels 12. The coupler material 102 is generally positioned between each panel of the plurality of panels 12 and the adjacent panel of the plurality of panels 12. For example, the coupler material 102 may comprise a fiber material that is flexible wherein the fiber material is configured to facilitate each panel of the plurality of panels 12 in pivoting upwardly and downwardly with respect to the adjacent panel of the plurality of panels 12. In some embodiments, the fiber material may include synthetic polymers such as polyester and nylon, which are durable and capable of withstanding exposure to the outdoor elements where the protective vehicle cover device 10 is used.

A plurality of fasteners 104 may be coupled to the plurality of panels 12. The plurality of fasteners 104 is generally configured to releasably affix the plurality of panels 12 to the vehicle 150. The plurality of fasteners 104 may be coupled to the top surface 14, adjacent to the peripheral edge 18 of the plurality of panels 12.

The plurality of fasteners 104 may further comprise a hood fastener 116 that is configured to affix the plurality of hood panels 20 to the vehicle 150. For example, the hood fastener 116 may be positioned on the third hood panel 28. A front windshield fastener 118 may be configured to affix the plurality of front windshield panels 44 to the vehicle 150. The front windshield fastener 118 may be positioned on the first front windshield panel 50, for example adjacent to the second front windshield panel 52. A first roof fastener 120 may be configured to affix the plurality of roof panels 54 to the vehicle 150. The first roof fastener 120 may be positioned on the second roof panel 60, for example adjacent to the first roof panel 58. A second roof fastener 122 may also be configured to affix the plurality of roof panels 54 to the vehicle 150. For example, the second roof fastener 122 may be positioned on the third roof panel 692 adjacent to the fourth roof panel 64. A rear windshield fastener 124 may be configured to affix the plurality of rear windshield panels 72 to the vehicle 150. The rear windshield fastener 124 may be positioned adjacent to a junction between the first rear windshield panel 76 and the second rear windshield panel 78. A trunk fastener 126 may be configured to affix the plurality of trunk panels 80 to the vehicle 150. For example, the trunk fastener 126 may be positioned on the second trunk panel 86 adjacent to the third trunk panel 88.

The exact number and positioning of each fastener of the plurality of fasteners 104 may vary between embodiments. For example, some embodiments may only include two fasteners, such as the hood fastener 116 and the trunk fastener 126, while others may include three or four fasteners of the plurality of fasteners 104. The plurality of fasteners 104 should keep the plurality of panels 12 securely tied to the vehicle 150. The plurality of fasteners 104 inhibit the plurality of panels 12 from flapping around or blowing off the vehicle 150 so that the plurality of panels 12 can cover the body of the vehicle 12 to inhibit impact damage. For example, the protective vehicle cover device 10 may be used during a thunderstorm or hailstorm, with high winds, so the plurality of fasteners 104 should include enough fasteners to keep the plurality of panels 12 secured over the vehicle 150 in such conditions.

Each fastener of the plurality of fasteners 104 may further comprise a first strap 106 that is coupled to and extends outwardly from a primary side 108 of an associated panel of the plurality of panels 12. A second strap 110 may be releasably couplable to the first strap 106. The second strap 110 may be coupled to and extend outwardly from a secondary side 112 of the associated panel of the plurality of panels 12. The second strap 110 is generally aligned with the first strap 106 across the associated panel of the plurality of panels 12.

A retainer 114 may be attached to the second strap 110. The first strap 106 may be engaged by the retainer 114 to couple the second strap 110 to the first strap 106. For example, the retainer 114 may comprising a pair of rings. In certain embodiments, each ring of the pair of rings may be a D-ring. In other examples, the retainer 114 may comprise a buckle, such as a slide buckle, a slide release buckle, a frame buckle, a ratchet buckle, or a snap buckle.

In embodiments, the first strap 106 may be run or snaked beneath the vehicle 150 to meet the second strap 110. The first strap 106 may be coupled to the second strap 110 on one side of the vehicle 150 to facilitate the user in releasing the retainer 114 to remove the plurality of panels 12 from the vehicle 10. Accordingly, the first strap 106 of each fastener of the plurality of fasteners 104 may have a length 48 exceeding a length 48 of the second strap 110 of each fastener of the plurality of fasteners 104.

The plurality of fasteners 104 may further include a pair of front bumper fasteners 158. The pair of front bumper fasteners 158 may be coupled to and extend outwardly from the forward edge 42 of the plurality of panels 12. Embodiments of the pair of front bumper fasteners 158 may be positioned on the top side hood panel piece 36 of the first hood panel 24 to secure the plurality of panels 12 to the front end 22 of the vehicle 150. For example, the pair of front bumper fasteners 158 may wrap around the tie-rods or another piece of the front suspension of the vehicle 150 to ensure that the first hood panel 24 remains securely positioned on the front end 22 of the vehicle 150. The pair of front bumper fasteners 158 may help ensure the plurality of panels 12 does not fly away or become displaced on the vehicle 150 in high winds or other extreme weather conditions.

A pair of rear bumper fasteners 160 may be coupled to and extend outwardly from the rear edge 94 of the plurality of panels 12. Embodiments of the pair of rear bumper fasteners 160 may be positioned on the top side trunk panel piece 98 of the fourth trunk panel 90 to secure the plurality of panels 12 to the rear end 82 of the vehicle 150. For example, the pair of rear bumper fasteners 160 may wrap around the sway bar or another piece of the rear suspension of the vehicle 150 to ensure that the fourth trunk panel 90 remains securely positioned on the rear end 82 of the vehicle 150. The pair of rear bumper fasteners 160 may help ensure the plurality of panels 12 does not fly away or become displaced on the vehicle 150 in high winds or other extreme weather conditions.

Each of the pair of front bumper fasteners 158 and the pair of rear bumper fasteners 160 may include an elongated band 162 and an attachment piece 164. The attachment piece 164 may be coupled to the elongated band 162. The attachment piece may be spaced from the plurality of panels 12 wherein the elongated band 162 is configured to wrap around a piece of the vehicle 150, such as the front or rear suspension of the vehicle 150, and engage the attachment piece 164. Embodiments of the attachment piece 164 may comprise D-rings.

Each panel of the plurality of panels 12 may be pivotable toward the adjacent panel of the plurality of panels 12 such that the plurality of panels 12 are foldable together into a storage configuration. For example, the plurality of panels 12 may be folded together like an accordion, by stacking each panel of the plurality of panels 12 over the adjacent panel of the plurality of panels 12. Folding the plurality of panels 12 together into the storage configuration will facilitate storage of the protective vehicle cover device 10, for example in the trunk of the vehicle 150.

A pair of sleeves 128 may be included in the protective vehicle cover device 10. The pair of sleeves 128 is generally configured to be positionable over a pair of side mirrors 130 of the vehicle 150. Each sleeve of the pair of sleeves 128 may comprise the resiliently compressible material to inhibit impact damage to the pair of side mirrors 130.

Each sleeve of the pair of sleeves 128 may further comprise a base wall 132 and a perimeter wall 134 that is coupled to and extends outwardly from the base wall 132 to define an interior space 136. The interior space 136 of each sleeve of the pair of sleeves 128 generally has a size that is configured to receive an associated side mirror of the pair of side mirrors 130 so that the associated side mirror can be positioned within one of the sleeves of the pair of sleeves 128.

An outer edge 138 of the perimeter wall 134 of each sleeve of the pair of sleeves 128 defines an opening 140 into the interior space 136. The opening 140 is generally configured to facilitate positioning the associated side mirror of the pair of side mirrors 130 within the interior space 136.

The perimeter wall 134 may include a first pair of opposing lateral sides 142 and a second pair of opposing lateral sides 144. The first pair of opposing lateral sides 142 may be perpendicular to the second pair of opposing lateral sides 144. A cutout 146 may extend into the outer edge 138 of each side of the second pair of opposing lateral sides 144. The cutout 146 may define a square bracket shape that is configured to receive an arm 148 coupling each side mirror of the pair of side mirrors 130 to the vehicle 150. For example, the square bracket shape may have rounded corners.

In use, the protective vehicle cover device 10 can be stored in the trunk interior of the vehicle 150. Once the vehicle 150 is parked, the plurality of panels 12 can be unfolded and positioned over the vehicle 150. The plurality of fasteners 104 can secure the plurality of panels 12 to the vehicle 150. The pair of sleeves 128 can be positioned over the pair of side mirrors 130 of the vehicle 150. The resiliently compressible material of the plurality of panels 12 and the pair of sleeves 128 can inhibit impact damage to the vehicle 150, for example during hailstorms or thunderstorms, or from debris that is propelled through the air from nearby traffic.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A protective cover assembly comprising:
a plurality of panels being coupled together, each panel of the plurality of panels being pivotable with respect to an adjacent panel of the plurality of panels wherein a shape of the plurality of panels is configured to be complementary to a shape of a vehicle when the plurality of panels is positioned over the vehicle, each panel of the plurality of panels comprising a resiliently compressible material being configured to inhibit impact damage to the vehicle when the plurality of panels is positioned over the vehicle, the plurality of panels further comprising:
a plurality of hood panels being configured to be positioned over a front end of the vehicle wherein the front end includes at least one of a hood, a grill, and a pair of headlights;
a plurality of front windshield panels being configured to be positioned over a front windshield of the vehicle;
a plurality of roof panels being configured to be positioned over a midsection of the vehicle wherein the midsection extends between the front windshield and a rear windshield of the vehicle;
a plurality of rear windshield panels being configured to be positioned over the rear windshield of the vehicle;
a plurality of trunk panels being configured to be positioned over a rear end of the vehicle wherein the rear end includes at least one of a trunk and a pair of taillights;
a plurality of fasteners being coupled to the plurality of panels, the plurality of fasteners being configured to releasably affix the plurality of panels to the vehicle; and
a pair of sleeves being configured to be positionable over a pair of side mirrors of the vehicle, each sleeve of the pair of sleeves comprising the resiliently compressible material.

2. The protective cover assembly of claim 1, the plurality of hood panels further comprising:
a first hood panel;
a second hood panel being coupled to the first hood panel;
a third hood panel being coupled to the second hood panel;
a fourth hood panel being coupled to the third hood panel; and
a fifth hood panel being coupled to the fourth hood panel.

3. The protective cover assembly of claim 1, each hood panel of the plurality of hood panels further comprising:
a driver's side hood panel piece being configured to be positioned over a driver's side of the front end of the vehicle;
a top side hood panel piece extending outwardly from the driver's side hood panel piece, the top side hood panel piece being configured to be positioned over a top side of the front end of the vehicle; and
a passenger's side hood panel piece extending outwardly from the top side hood panel piece, the passenger's side hood panel piece being configured to be positioned over a passenger's side of the front end of the vehicle.

4. The protective cover assembly of claim 1, wherein each of the plurality of front windshield panels and the plurality of rear windshield panels has a length being smaller than a length of the plurality of hood panels.

5. The protective cover assembly of claim 1, the plurality of front windshield panels further comprising:
a first front windshield panel; and
a second front windshield panel being coupled to the first front windshield panel.

6. The protective cover assembly of claim 1, the plurality of roof panels further comprising:
a first roof panel;
a second roof panel being coupled to the first roof panel;
a third roof panel being coupled to the second roof panel; and
a fourth roof panel being coupled to the third roof panel.

7. The protective cover assembly of claim 1, each roof panel of the plurality of roof panels further comprising:
a driver's side roof panel piece being configured to be positioned over a driver's side of the midsection of the vehicle;
a top side roof panel piece extending outwardly from the driver's side roof panel piece, the top side roof panel piece being configured to be positioned over a top side of the midsection of the vehicle; and
a passenger's side roof panel piece extending outwardly from the top side roof panel piece, the passenger's side roof panel piece being configured to be positioned over a passenger's side of the midsection of the vehicle.

8. The protective cover assembly of claim 1, the plurality of rear windshield panels further comprising:
a first rear windshield panel; and
a second rear windshield panel being coupled to the first rear windshield panel.

9. The protective cover assembly of claim 1, the plurality of trunk panels further comprising:
a first trunk panel;
a second trunk panel being coupled to the first trunk panel;
a third trunk panel being coupled to the second trunk panel; and
a fourth trunk panel being coupled to the third trunk panel.

10. The protective cover assembly of claim 1, each trunk panel of the plurality of trunk panels further comprising:
a driver's side trunk panel piece being configured to be positioned over a driver's side of the rear end of the vehicle;
a top side trunk panel piece being pivotably coupled to the driver's side trunk panel piece, the top side trunk panel piece being configured to be positioned over a top side of the rear end of the vehicle; and
a passenger's side trunk panel piece being pivotably coupled to the top side trunk panel piece, the passenger's side trunk panel piece being configured to be positioned over a passenger's side of the rear end of the vehicle.

11. The protective cover assembly of claim 1, further comprising a coupler material pivotably connecting each panel of the plurality of panels to an adjacent panel of the plurality of panels, the coupler material being positioned between each panel of the plurality of panels and the adjacent panel of the plurality of panels.

12. The protective cover assembly of claim 1, each fastener of the plurality of fasteners further comprising:
a first strap being coupled to and extending outwardly from a primary side of an associated panel of the plurality of panels; and
a second strap being releasably couplable to the first strap, the second strap being coupled to and extending outwardly from a secondary side of the associated panel of the plurality of panels, the second strap being aligned with the first strap across the associated panel.

13. The protective cover assembly of claim 12, further comprising a retainer being attached to the second strap, the first strap being engaged by the retainer to couple the second strap to the first strap.

14. The protective cover assembly of claim 13, the retainer further comprising a pair of rings.

15. The protective cover assembly of claim 1, the plurality of fasteners further comprising:
a hood fastener being positioned on the plurality of hood panels; and
a trunk fastener being positioned on the plurality of trunk panels.

16. The protective cover assembly of claim 1, each sleeve of the pair of sleeves further comprising:
a base wall; and
a perimeter wall being coupled to and extending outwardly from the base wall to define an interior space, the interior space of each sleeve of the pair of sleeves having a size being configured to receive an associated side mirror of the pair of side mirrors.

17. The protective cover assembly of claim 16, wherein an outer edge of the perimeter wall defines an opening into the interior space.

18. The protective cover assembly of claim 16, wherein the perimeter wall having a first pair of opposing lateral sides and a second pair of opposing lateral sides, the first pair of opposing lateral sides being perpendicular to the second pair of opposing lateral sides.

19. The protective cover assembly of claim 18, further comprising a cutout extending into the outer edge of each side of the second pair of opposing lateral sides of the perimeter wall of each sleeve of the pair of sleeves, the cutout defining a square bracket shape being configured to receive an arm coupling each side mirror of the pair of side mirrors to the vehicle.

20. A protective cover assembly comprising:
a plurality of panels being coupled together, each panel of the plurality of panels being pivotable upward and downward with respect to an adjacent panel of the plurality of panels wherein a shape of the plurality of panels is configured to be complementary to a shape of a vehicle when the plurality of panels is positioned over the vehicle, each panel of the plurality of panels comprising a resiliently compressible material being configured to inhibit impact damage to the vehicle when the plurality of panels is positioned over the vehicle, the resiliently compressible material comprising one of a high-density foam material and a sponge rubber material, each panel of the plurality of panels having a top surface, a bottom surface, and a peripheral edge being coupled to and extending between the top surface and the bottom surface, each panel of the plurality of panels having a thickness between 0.25 inch and 1.5 inch, the plurality of panels further comprising:
a plurality of hood panels being configured to be positioned over a front end of the vehicle wherein the front end includes at least one of a hood, a grill, and a pair of headlights, the plurality of hood panels further comprising:
a first hood panel;
a second hood panel being pivotably coupled to the first hood panel;
a third hood panel being pivotably coupled to the second hood panel;
a fourth hood panel being pivotably coupled to the third hood panel;
a fifth hood panel being pivotably coupled to the fourth hood panel;
each hood panel of the plurality of hood panels further comprising:
a driver's side hood panel piece being configured to be positioned over a driver's side of the front end of the vehicle;
a top side hood panel piece being pivotably coupled to and extending outwardly from the driver's side hood panel piece, the top side hood panel piece being configured to be positioned over a top side of the front end of the vehicle;
a passenger's side hood panel piece being pivotably coupled to and extending outwardly from the top side hood panel piece, the passenger's side hood panel piece being positioned distally to the driver's side hood panel piece, the passenger's side hood panel piece being configured to be positioned over a passenger's side of the front end of the vehicle;
a plurality of front windshield panels being configured to be positioned over a front windshield of the vehicle, the plurality of front windshield panels being coupled to and extending outwardly from the plurality of hood panels, the plurality of front windshield panels further comprising:
a first front windshield panel being pivotably coupled to the fifth hood panel;
a second front windshield panel being pivotably coupled to the first front windshield panel;
a plurality of roof panels being configured to be positioned over a midsection of the vehicle wherein the midsection extends between the front windshield and a rear windshield of the vehicle, the plurality of roof panels being coupled to and extending outwardly from the plurality of front windshield panels, the plurality of roof panels further comprising:
a first roof panel being pivotably coupled to the second front windshield panel;
a second roof panel being pivotably coupled to the first roof panel;
a third roof panel being pivotably coupled to the second roof panel;
a fourth roof panel being pivotably coupled to the third roof panel;
each roof panel of the plurality of roof panels further comprising:
a driver's side roof panel piece being configured to be positioned over the driver's side of the midsection of the vehicle;
a top side roof panel piece being pivotably coupled to and extending outwardly from the driver's side roof panel piece, the top side roof panel piece being configured to be positioned over the top side of the midsection of the vehicle;
a passenger's side roof panel piece being pivotably coupled to and extending outwardly from the top side roof panel piece, the passenger's side roof panel piece being positioned distally to the driver's side roof panel piece, the passenger's side roof panel piece being configured to be positioned over the passenger's side of the midsection of the vehicle;
a plurality of rear windshield panels being configured to be positioned over the rear windshield of the vehicle, the plurality of rear windshield panels being coupled to and extending outwardly from the plurality of roof panels, the plurality of rear windshield panels further comprising:
a first rear windshield panel being pivotably coupled to the fourth roof panel;
a second rear windshield panel being pivotably coupled to the first rear windshield panel;
a plurality of trunk panels being configured to be positioned over a rear end of the vehicle wherein the rear end includes at least one of a trunk and a pair of taillights, the plurality of trunk panels being coupled to and extending outwardly from the plurality of rear windshield panels, the plurality of trunk panels further comprising:
a first trunk panel being pivotably coupled to the second rear windshield panel;
a second trunk panel being pivotably coupled to the first trunk panel;
a third trunk panel being pivotably coupled to the second trunk panel;
a fourth trunk panel being pivotably coupled to the third trunk panel;
each trunk panel of the plurality of trunk panels further comprising:
a driver's side trunk panel piece being configured to be positioned over the driver's side of the rear end of the vehicle;
a top side trunk panel piece being pivotably coupled to and extending outwardly from the driver's side trunk panel piece, the top side trunk panel piece being configured to be positioned over the top side of the rear end of the vehicle;
a passenger's side trunk panel piece being pivotably coupled to and extending outwardly from the top side trunk panel piece, the passenger's side trunk panel piece being positioned distally to the driver's side trunk panel piece, the passenger's side trunk panel piece being configured to be positioned over the passenger's side of the rear end of the vehicle;
wherein the driver's side roof panel piece of each roof panel of the plurality of roof panels has a length exceeding a length of the driver's side hood panel piece of each hood panel of the plurality of hood panels, and wherein the driver's side roof panel piece of each roof panel of the plurality of roof panels has a length exceeding a length of the driver's side trunk panel piece of each trunk panel of the plurality of trunk panels;
wherein the passenger's side roof panel piece of each roof panel of the plurality of roof panels has a length exceeding a length of the passenger's side hood panel piece of each hood panel of the plurality of hood panels and wherein the passenger's side roof panel piece of each roof panel of the plurality of roof panels has a length exceeding a length of the passenger's side trunk panel piece of each trunk panel of the plurality of trunk panels;
wherein the top side roof panel piece of each roof panel of the plurality of roof panels has a length being equal to a length of the top side hood panel piece of each hood panel of the plurality of hood panels and wherein the top side roof panel piece of each roof panel of the plurality of roof panels has a length being equal to a length of the top side trunk panel piece of each trunk panel of the plurality of trunk panels;
a coupler material pivotably connecting each panel of the plurality of panels to an adjacent panel of the plurality of panels, the coupler material being positioned between each panel of the plurality of panels and the adjacent panel of the plurality of panels, the coupler material comprising a fiber material being flexible wherein the fiber material is configured to facilitate each panel of the plurality of panels in pivoting upwardly and downwardly with respect to the adjacent panel of the plurality of panels;
a plurality of fasteners being coupled to the plurality of panels, the plurality of fasteners being configured to releasably affix the plurality of panels to the vehicle, the plurality of fasteners being coupled to the top surface adjacent to the peripheral edge of the plurality of panels, each fastener of the plurality of fasteners further comprising:
a first strap being coupled to and extending outwardly from a primary side of an associated panel of the plurality of panels;
a second strap being releasably couplable to the first strap, the second strap being coupled to and extending outwardly from a secondary side of the associated panel of the plurality of panels, the second strap being aligned with the first strap across the associated panel;
a retainer being attached to the second strap, the first strap being engaged by the retainer to couple the second strap to the first strap, the retainer comprising a pair of rings, each ring of the pair of rings being a D-ring;
the plurality of fasteners further comprising:
a hood fastener being configured to affix the plurality of hood panels to the vehicle, the hood fastener being positioned on the third hood panel;
a front windshield fastener being configured to affix the plurality of front windshield panels to the vehicle, the front windshield fastener being positioned on the first front windshield panel adjacent to the second front windshield panel;
a first roof fastener being configured to affix the plurality of roof panels to the vehicle, the first roof fastener being positioned on the second roof panel adjacent to the first roof panel;
a second roof fastener being configured to affix the plurality of roof panels to the vehicle, the second roof fastener being positioned on the third roof panel adjacent to the fourth roof panel;
a rear windshield fastener being configured to affix the plurality of rear windshield panels to the vehicle, the rear windshield fastener being positioned adjacent to a junction between the first rear windshield panel and the second rear windshield panel;
a trunk fastener being configured to affix the plurality of trunk panels to the vehicle, the trunk fastener being positioned on the second trunk panel adjacent to the third trunk panel;
a pair of sleeves being configured to be positionable over a pair of side mirrors of the vehicle, each sleeve of the pair of sleeves comprising the resiliently compressible material, each sleeve of the pair of sleeves further comprising:
a base wall;
a perimeter wall being coupled to and extending outwardly from the base wall to define an interior space, the interior space of each sleeve of the pair of sleeves having a size being configured to receive an associated side mirror of the pair of side mirrors;
an outer edge of the perimeter wall defining an opening into the interior space;
the perimeter wall having a first pair of opposing lateral sides and a second pair of opposing lateral sides, the first pair of opposing lateral sides being perpendicular to the second pair of opposing lateral sides; and
a cutout extending into the outer edge of each side of the second pair of opposing lateral sides, the cutout defining a square bracket shape being configured to receive an arm coupling each side mirror of the pair of side mirrors to the vehicle, the square bracket shape having rounded corners.
